(19) United States
(12) Patent Application Publication
(10) Pub. No.: US 2010/0138876 A1
(43) Pub. Date: Jun. 3, 2010

(54) SYSTEM AND METHOD TO TRANSMIT MEDIA CONTENT

(75) Inventors: Marc Sullivan, Austin, TX (US); James Pratt, Round Rock, TX (US); Steven Belz, Cedar Park, TX (US)

Correspondence Address: AT & T LEGAL DEPARTMENT - Toler;ATTN: PATENT DOCKETING, ROOM 2A-207, ONE AT & T WAY, BEDMINISTER, NJ, 07921, US

(73) Assignee: AT&T Intellectual Property I, L.P., Reno, NV (US)

(21) Appl. No.: 12/325,996

(22) Filed: Dec. 1, 2008

(51) Int. Cl. H04N 7/16

(52) U.S. Cl. 725/62

(57) ABSTRACT

A system is disclosed that includes a receiving module to receive a request for media content from a mobile electronic device. The system also includes a broadcast module to transmit the requested media content to the mobile electronic device via a broadcast transmission over a first wireless network. The system also includes a unicast module to transmit the requested media content to the mobile electronic device via a unicast transmission over a second wireless network. The second wireless network is different from the first wireless network.

### FIELD OF THE DISCLOSURE

The present disclosure is generally related to systems and methods to transmit media content.

### BACKGROUND

Consumers have an ever increasing amount of available content, including television, Internet, radio, gaming, and other sources. More and more of this content is being broadcast to viewers. Often, a broadcast provider may have several broadcasts or channels the user can select from. One of the drawbacks of broadcasting content is that when a user wants to change a channel and view a different broadcast, there can be a noticeable time delay before the next channel is displayed. This is because the broadcast content is typically compressed (such as a video frame in video compression).

In video compression, there may be three types of frames: I frames are the least compressible but do not require other video frames to decode; P frames can use data from previous I frames to decompress and are more compressible than I frames; and B frames can use both previous and forward frames for data reference to get the highest amount of data compression. Hence, before a video can be displayed, an I frame is received and decompressed in order to decompress the P and B frames, which can produce a noticeable time delay.

### BRIEF DESCRIPTION OF THE DRAWINGS

FIG. 1 is a block diagram of a first particular embodiment of a system to transmit media content;

FIG. 2 is a block diagram of a second particular embodiment of a system to transmit media content;

FIG. 3 is a flow diagram of a first particular illustrative embodiment of a method to transmit media content;

FIG. 4 is a flow diagram of a particular illustrative embodiment of a channel change method; and

FIG. 5 is a block diagram of a particular embodiment of a general computing system.

### DETAILED DESCRIPTION OF THE DRAWINGS

In a particular embodiment, a system is disclosed that includes a receiving module to receive a request for media content from a mobile electronic device, a broadcast module to transmit the requested media content to the mobile electronic device via a broadcast transmission over a first wireless network, and a unicast module to transmit the requested media content to the mobile electronic device via a unicast transmission over a second wireless network. The second wireless network is different from the first wireless network.

In another particular embodiment, a method is disclosed that includes broadcasting media content to a mobile electronic device via a first wireless transmission over a first wireless network. The method also includes unicast bursting the media content to the mobile electronic device via a second wireless transmission over a second wireless network. The second wireless network is different from the first wireless network.

In another particular embodiment, a mobile communication device is disclosed that includes logic to transmit a request for media content. The mobile communication device also includes logic to receive a broadcast transmission of the media content over a first wireless network. The mobile communication device also includes logic to receive a unicast burst transmission of the media content over a second wireless network. The second wireless network is different from the first wireless network.

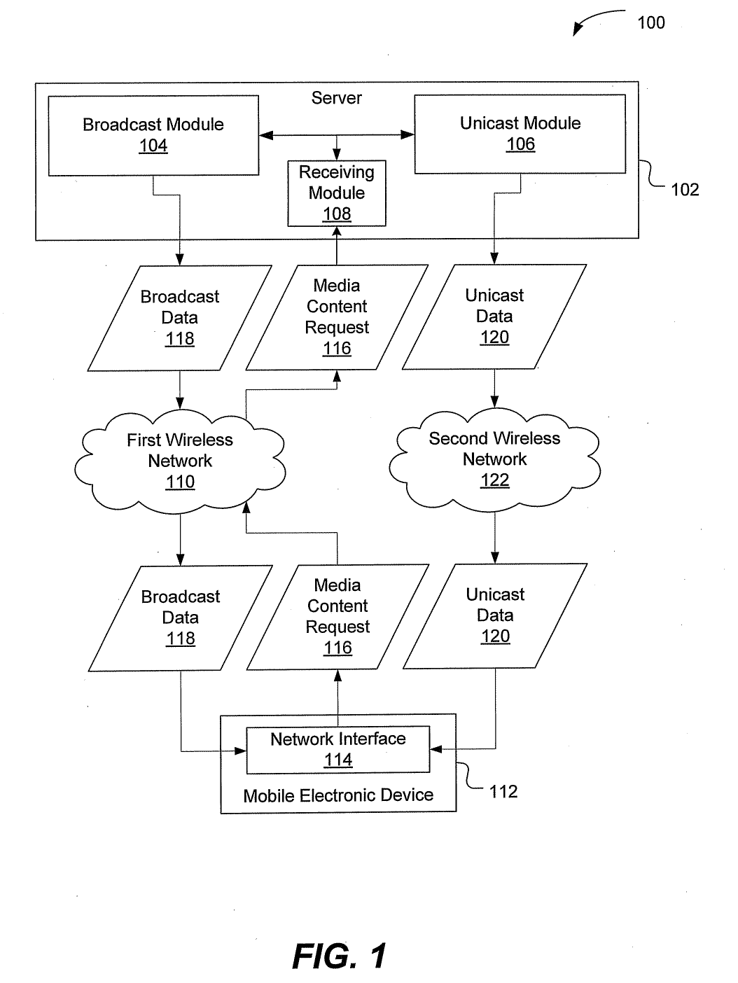

Referring to FIG. 1, a system to transmit media content is depicted and generally designated 100. The system 100 includes a server 102 in communication with a media receiver, such as a representative mobile electronic device 112 via a first wireless network 110 and a second wireless network 122. The system 100 simultaneously broadcasts and unicasts media content to be displayed on the mobile electronic device 112. The unicast data is displayed at the mobile electronic device 112 until the broadcast data has been decompressed. The unicast transmission of the media content may then be stopped, and the broadcast transmission of the media content may be displayed.

In a particular embodiment, the server 102 includes a receiving module 108, a broadcast module 104, and a unicast module 106. The server 102 is configured to receive requests 116 for specific media content (e.g., a specific television channel) via the receiving module 108. Upon receiving the request 116, the server 102 is configured to access the broadcast module 104 and the unicast module 106 to initiate a transmission of the requested media content to the mobile electronic device 112. For example, the media content may include any combination of video content, audio content, closed captioning content, white space content, or other types of content. In a particular embodiment, the media content may include television content.

In a particular embodiment, the mobile electronic device 112 includes a network interface 114. The network interface 114 is configured to receive requests 116 for media content from a user and to transmit the request 116 to the receiving module 108 of the server 102 via the first wireless network 110. Further, the network interface 114 is adapted to receive broadcast data 118 transmitted from the server 102 via a broadcast transmission over the first wireless network 110. The network interface 114 is further adapted to receive unicast data 120 transmitted from the server 102 via a unicast transmission (e.g., a burst transmission) over the second wireless network 120.

During operation, a user of the mobile electronic device 112 may request media content. For example, the user may select a multimedia channel (e.g., a mobile television channel) for display on the mobile electronic device 112. Once the multimedia channel is selected by the user, the mobile electronic device 112 sends a request 116 for the media content (e.g., a request for a particular mobile television channel), via the network interface 114, to the receiving module 108 of the server 102. The request 116 is transmitted over the first wireless network 110. After the receiving module 108 of the server 102 receives the request 116 for the media content, the receiving module 108 activates the broadcast module 104 to broadcast the requested media content as broadcast data 118. The broadcast data 118 is transmitted over the first wireless network 110. Further, the receiving module 108 activates the unicast module 106 to unicast the requested media content as unicast data 120. The unicast data 120 is transmitted over the second wireless network 122. The second wireless network 122 is different from the first wireless network 110. In a particular embodiment, the mobile electronic device 112 displays the unicast data 120 transmitted from the unicast module 106 until a received and decompressed frame transmitted from the broadcast module 104 corresponds to a received frame transmitted from the unicast module 106. The mobile electronic device 112 may then begin to display the media content transmitted from the broadcast module 104 (e.g., the broadcast data 118), and the unicast transmission from the unicast module 106 may be terminated. In a particular embodiment, when the broadcast data 118 has been decompressed, the mobile electronic device 112 sends a signal to the server 102 to stop transmitting the unicast data 120 from the unicast module 106.

In a particular embodiment, the requested media content is transmitted from the unicast module 106 in a burst for a predetermined amount of time. For example, the predetermined amount of time may be sufficient for the broadcast data 118 to be decompressed. In a particular embodiment, the predetermined amount of time is about one second. Alternatively, the unicast data 120 may be transmitted for any other predetermined amount of time. The data transfer rate of the unicast burst transmission may be sufficient for a user to avoid significant lag time between sending the request 116 for the media content and the media content being displayed at the mobile electronic device 112.

Typically, if a user has to wait more than 500 milliseconds (ms) to view the requested media content 116 (e.g., a new television channel), the user may experience a lag or noticeable wait time for a channel change. Decompression of broadcast data 118 may result in such a noticeable time delay, possibly resulting in a poor user experience. Alternatively, a lag time between 300 ms and 400 ms may not be noticeable to the user. By simultaneously broadcasting and unicasting the requested media content 116 to the mobile electronic device 112 and displaying the unicast data 118 until the broadcast data 118 has been decompressed, the system 100 may enable a near real-time display (e.g., the lag time may not be noticeable to the user) of the requested media content 116. This may allow the user to avoid waiting for a reference frame such as an I frame to be received and decompressed before the user can begin to view the requested media content 116. Hence, the user experience may be enhanced.

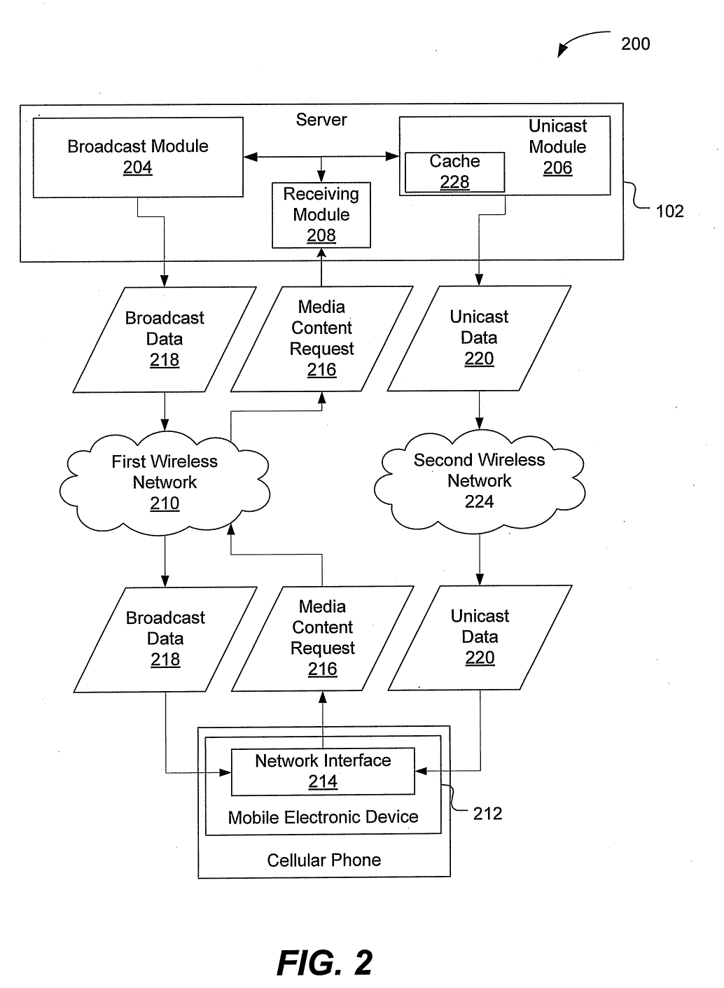

Referring to FIG. 2, a system to transmit media content is depicted and generally designated 200. The system 200 includes a server 202 in communication with a media receiver via multiple wireless networks. In the embodiment shown, the multiple wireless networks include a first wireless network 210 and a second wireless network 224. In a particular embodiment, the media receiver is a mobile electronic device 212 contained in a vehicle or in a cellular telephone. In a particular embodiment, the wireless networks 210 and 224 include a third generation (3G) wireless network or a fourth generation (4G) wireless network. The server 202 simultaneously broadcasts and unicasts the media content to be displayed on the mobile electronic device 212 and displays the unicast data 220 until the broadcast data 218 has been decompressed. The unicast transmission of the unicast data 220 may then be stopped and the broadcast transmission of the broadcast data 218 may be displayed at the mobile electronic device 212.

In a particular embodiment, the server 202 includes a receiving module 208, a broadcast module 204, and a unicast module 206. The server 202 is configured to receive a request 216 for specific media content (e.g., a television channel) via the receiving module 208. Upon receiving the request, the server 202 is configured to access the broadcast module 204 and the unicast module 206 to initiate a transmission of the requested media content 216 to the mobile electronic device 212. For example, the media content may include any combination of video content, audio content, closed captioning content, white space content, or other types of content. In a particular embodiment, the media content may include television content.

In the embodiment shown in FIG. 2, the unicast module 206 contains a cache 228. The cache 228 stores a predetermined amount of media content to be unicast by the unicast module 206. In a particular embodiment, the content in the cache 228 includes data related to a plurality of media content channels (e.g., mobile television channels). In a particular embodiment, the size of the content in the cache 228 is at least the size of data that the unicast module 206 would have to unicast to the mobile electronic device 212 until a decompressed frame transmitted from the broadcast module 204 and a corresponding frame transmitted from the unicast module 206 have been received by the mobile electronic device 212. For example, the size of the content of cache 228 may depend on the data rate of the network. In a particular embodiment, the data stored in the cache 228 includes at least about one second of media content for each media channel. Alternatively, the data stored in the cache 228 may include any other amount of cached media content. In a particular embodiment, the data stored in the cache 228 includes descriptive information associated with the media content such as a program summary and descriptive information about the media such as channel descriptions, program titles, ratings and lists of actors, among other alternatives.

In a particular embodiment, the mobile electronic device 212 includes a network interface 214. The network interface 214 is configured to receive requests 216 for media content from a user and transmit the request 216 to the receiving module 208 of the server 202 via the first wireless network 210. Further, the network interface 214 is adapted to receive broadcast data 118 transmitted from the server 202 via a broadcast transmission over the first wireless network 210. The network interface 214 is further adapted to receive unicast data 220 transmitted from the server 202 via a unicast transmission over the second wireless network 224.

During operation, a user of the mobile electronic device 212 may select a broadcast channel. For example, the user may select a multimedia channel for display on the mobile electronic device 212. Once the channel is selected by the user, the mobile electronic device 212 sends a request 216, via the network interface 214, to the receiving module 208 of the server 202. The request 216 is transmitted over the first wireless network 210. After the receiving module 208 receives the request 216 for the media content, the receiving module 208 of the server 202 activates the broadcast module 204 to broadcast the requested media content as broadcast data 218 over the first wireless network 210, and the receiving module 208 activates the cache 228 in the unicast module 206 to unicast the requested media content as unicast data 220 over the second wireless network 224.

In a particular embodiment, the mobile electronic device 212 displays the unicast data 220 transmitted from the cache 228 until the broadcast data 218 has been decompressed. The mobile electronic device 212 may then begin to display the broadcast data 218 transmitted from the broadcast module 204. In a particular embodiment, when the broadcast data 218 has been decompressed, the mobile electronic device 212 sends a signal to the server 202 to stop the transmission of unicast data 220 from the cache 228 of the unicast module 206. Alternatively, the unicast data 220 may be transmitted for a predetermined amount of time, and the mobile electronic device 212 may not transmit a signal to the server 202.

By caching media content that may be broadcast, then simultaneously broadcasting and unicasting the media content to a mobile electronic device and displaying the unicast data 220 until the broadcast data 218 has been decompressed, the system 200 may enable a near real-time display of the requested media content 216 (e.g., a near real-time change of television channels). This may allow the user to avoid waiting for a reference frame such as an I frame to be received and decompressed before the user can begin to view the requested media content 216. Hence, the user experience may be enhanced.

As noted above, the mobile electronic device may be mounted in a vehicle 226 or may be a cellular telephone 228. Alternatively, the mobile electronic device 212 may be contained in a portable digital assistant (PDA), a gaming device, or other similar devices. Also, the modules described (e.g., the broadcast module 204, unicast module 206 and receiving module 208) may be hardware, software, or firmware. In addition, the modules (and the associated cache 228) may be located at different network locations.

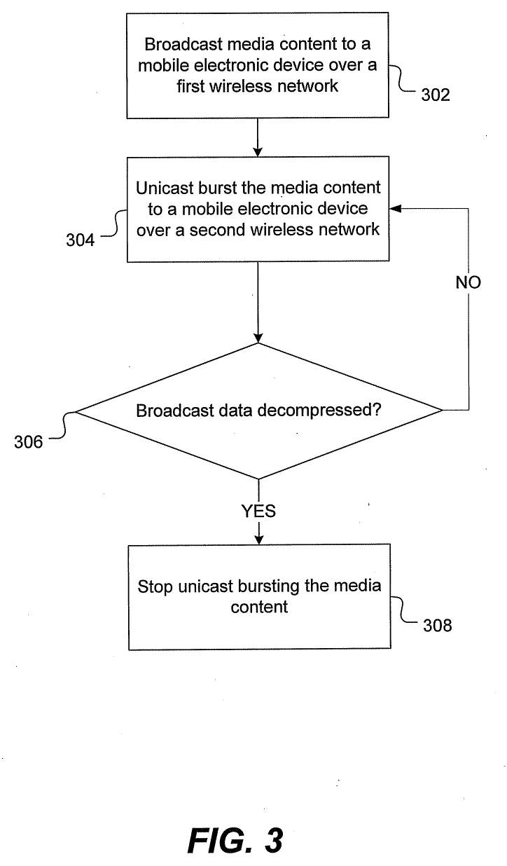

FIG. 3 is a flow diagram of a particular illustrative embodiment of a method of transmitting media content. Media content is broadcast to a mobile electronic device over a first wireless network, at 302. For example, the first wireless network may be the first wireless network 110 of FIG. 1 or the first wireless network 210 of FIG. 2, and the mobile electronic device may be the mobile electronic device 112 of FIG. 1 or the mobile electronic device 212 of FIG. 2. Moving to 304, the media content is transmitted to the mobile electronic device via a unicast burst transmission over a second wireless network. The second wireless network is different from the first wireless network. For example, the second wireless network may be the second wireless network 122 of FIG. 1 or the second wireless network 224 of FIG. 2. At 306, a determination is made whether the broadcast data has been decompressed. For example, the mobile electronic device 112 of FIG. 1 determines if the broadcast data 118 has been decompressed and sends a signal to receiving module 108 of the server 102. If the broadcast data has been decompressed, then the unicast burst transmission of the media content continues, at 304. Otherwise, the unicast bursting of the media content may be terminated, at 308.

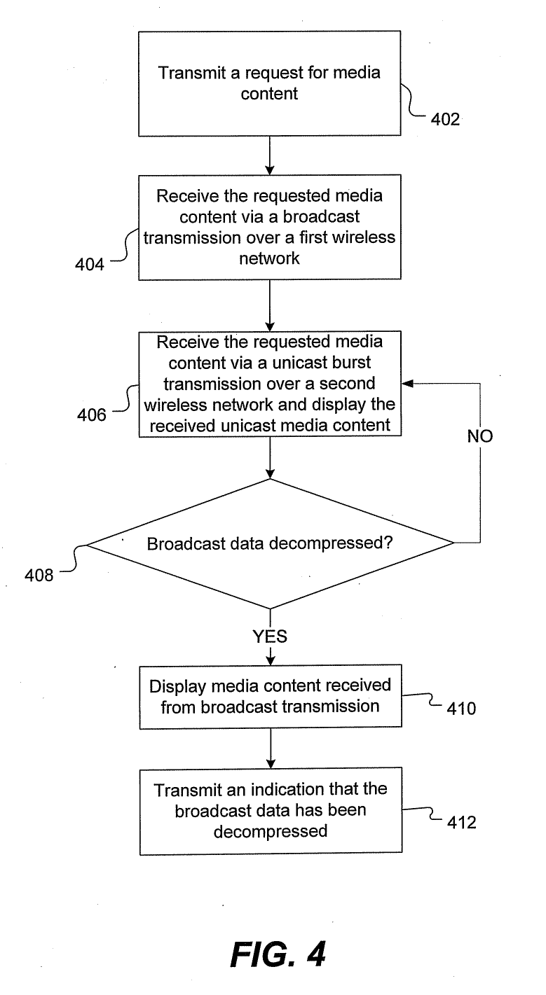

FIG. 4 is a flow diagram of a particular illustrative embodiment of a channel change method. A request for media content is transmitted, at 402. For example, with reference to FIG. 1, a request 116 for media content is sent to the receiving module 108 of the server 102 over the first wireless network 110. At 404, the requested media content is received via a broadcast transmission over a first wireless network. For example, the broadcast module 104 of FIG. 1 may transmit broadcast data 118 over the first wireless network 110. Continuing to 406, the requested media content 116 is received through a wireless unicast burst over a second wireless network, and the received unicast content is displayed. For example, the unicast module 106 of FIG. 1 may transmit unicast data 120 over the second wireless network 122, and the mobile electronic device 112 may display the received unicast data 120. At 408, a determination is made whether the broadcast data has been decompressed. For example, the mobile electronic device 112 of FIG. 1 determines whether the broadcast data 118 has been decompressed. If the broadcast data has been decompressed, then the requested media content continues to be received through the wireless unicast burst transmission, at 406. Otherwise, advancing to 410, if the broadcast data has been decompressed, then the media content received from broadcast transmission is displayed. For example, the broadcast data 118 of FIG. 1 may be displayed. In a particular embodiment, an indication is transmitted that the broadcast data has been decompressed. For example, the mobile electronic device 112 of FIG. 1 may transmit an indication to the server 102 that the broadcast data 118 has been decompressed. In response to the indication, the server 102 may stop transmission of unicast data 120 over the second wireless network 122.

Although the particular embodiments of the above-described methods have been presented in a particular sequence, it should be understood that the sequences are presented for illustrative purposes, and that in other embodiments the methods may be performed in a number of alternative sequences. In addition, other embodiments can have more or less steps than depicted.

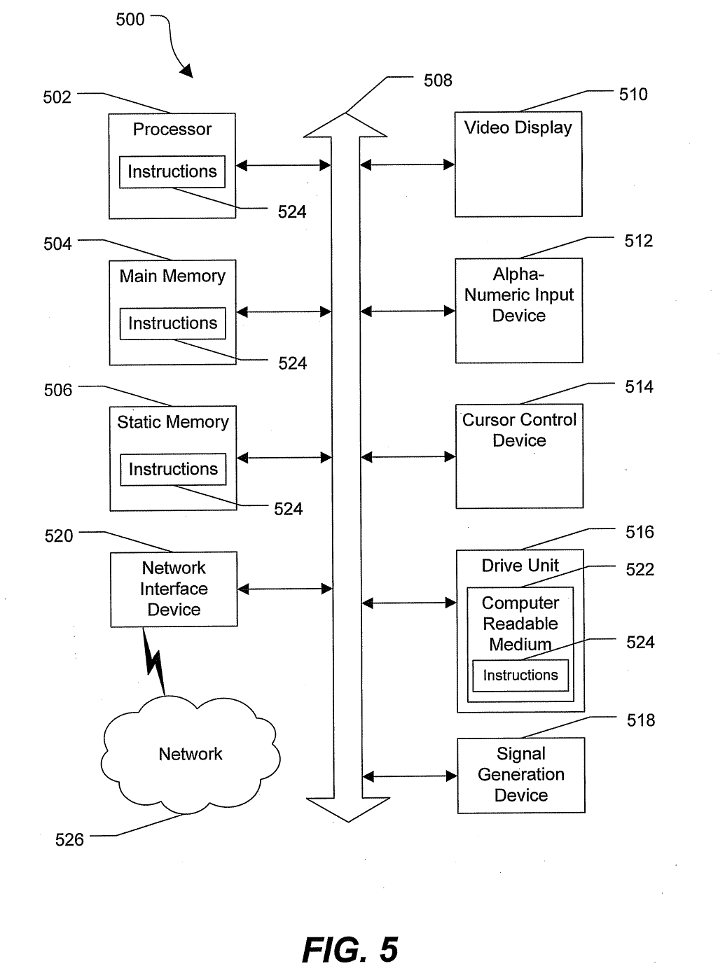

Referring to FIG. 5, an illustrative embodiment of a general computer system is shown and is designated 500. The computer system 500 can include a set of instructions that can be executed to cause the computer system 500 to perform any one or more of the methods or computer based functions disclosed herein. The computer system 500 can operate as a standalone device or can be connected, e.g., using a network, to other computer systems or peripheral devices, such as the systems and electronic devices shown in FIGS. 1 and 2. For example, the computer system 500 may be included in the server 102, broadcast module 104, unicast module 106, receiving module 108, or mobile electronic device 112 of FIG. 1, or the server 202, broadcast module 204, unicast module 206, receiving module 208, or mobile electronic device 212 of FIG. 2, or any combination thereof.

In a networked deployment, the computer system can operate in the capacity of a server or as a client user computer in a server-client user network environment, or as a peer computer system in a peer-to-peer (or distributed) network environment. The computer system 500 can also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In a particular embodiment, the computer system 500 can be implemented using electronic devices that provide voice, video or data communication. Further, while a single computer system 500 is illustrated, the term “system” shall also be taken to include any collection of systems or sub-systems that individually or jointly execute a set, or multiple sets, of instructions to perform one or more computer functions.

As illustrated in FIG. 5, the computer system 500 can include a processor 502, e.g., a central processing unit (CPU), a graphics processing unit (GPU), or both. Moreover, the computer system 500 can include a main memory 504 and a static memory 505, that can communicate with each other via a bus 508. As shown, the computer system 500 can further include a video display unit 510, such as a liquid crystal display (LCD), an organic light emitting diode (OLED), a flat panel display, a solid state display, or a cathode ray tube (CRT). Additionally, the computer system 500 can include an input device 512, such as a keyboard, and a cursor control device 514, such as a mouse. The computer system 500 can also include a disk drive unit 515, a signal generation device 518, such as a speaker or remote control, and a network interface device 520.

In a particular embodiment, as depicted in FIG. 5, the disk drive unit 515 can include a computer-readable medium 522 in which one or more sets of instructions 524, e.g. software, can be embedded. Further, the instructions 524 can embody one or more of the methods or logic as described herein. In a particular embodiment, the instructions 524 can reside completely, or at least partially, within the main memory 504, the static memory 505, and/or within the processor 502 during execution by the computer system 500. The main memory 504 and the processor 502 also can include computer-readable media.

In an alternative embodiment, dedicated hardware implementations, such as application specific integrated circuits, programmable logic arrays and other hardware devices, can be constructed to implement one or more of the methods described herein. Applications that can include the apparatus and systems of various embodiments can broadly include a variety of electronic and computer systems. One or more embodiments described herein can implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein can be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

The present disclosure contemplates a computer-readable medium that includes instructions 524 or receives and executes instructions 524 responsive to a propagated signal, so that a device connected to a network 525 can communicate voice, video or data over the network 525. Further, the instructions 524 can be transmitted or received over the network 525 via the network interface device 520.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. A digital file attachment to an e-mail or other self-contained information archive or set of archives can be considered a distribution medium that is equivalent to a tangible storage medium. Accordingly, the disclosure is considered to include any one or more of a computer-readable medium or a distribution medium and other equivalents and successor media, in which data or instructions can be stored.

Although the present specification describes components and functions that can be implemented in particular embodiments with reference to particular standards and protocols, the invention is not limited to such standards and protocols. For example, standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same or similar functions as those disclosed herein are considered equivalents thereof.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments can be apparent to those of skill in the art upon reviewing the disclosure. Other embodiments can be utilized and derived from the disclosure, such that structural and logical substitutions and changes can be made without departing from the scope of the disclosure. Additionally, the illustrations are merely representational and can not be drawn to scale. Certain proportions within the illustrations can be exaggerated, while other proportions can be minimized. Accordingly, the disclosure and the figures are to be regarded as illustrative rather than restrictive.

One or more embodiments of the disclosure can be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose can be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features can be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter can be directed to less than all of the features of any of the disclosed embodiments. Thus, the following claims are incorporated into the Detailed Description, with each claim standing on its own as defining separately claimed subject matter.

The above-disclosed subject matter is to be considered illustrative, and not restrictive, and the appended claims are intended to cover all such modifications, enhancements, and other embodiments that fall within the true scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A system comprising:
a receiving module to receive a request for media content from a mobile electronic device;
a broadcast module to transmit the requested media content to the mobile electronic device via a broadcast transmission over a first wireless network; and
a unicast module to transmit the requested media content to the mobile electronic device via a unicast transmission over a second wireless network, wherein the second wireless network is different from the first wireless network.

2. The system of claim 1, wherein the second wireless network includes a third generation (3G) wireless network.

3. The system of claim 1, wherein the second wireless network includes a fourth generation (4G) wireless network.

4. The system of claim 1, wherein the requested media content includes television content.

5. The system of claim 1, wherein the receiving module receives data from the mobile electronic device, wherein the received data indicates that broadcast data from the broadcast transmission has been decompressed.

6. The system of claim 5, wherein the unicast transmission is terminated in response to the received data.

7. The system of claim 1, further comprising a cache, wherein the cache stores data that includes media content associated with a plurality of television channels.

8. The system of claim 7, wherein the stored data includes at least about one second of media content for each television channel of the plurality of television channels.

9. The system of claim 7, wherein the cache further stores descriptive information associated with the media content, the descriptive information including a program summary.

10. The system of claim 7, wherein the cache further stores descriptive information associated with the media content, the descriptive information including a list of actors.

11. A method, comprising:
broadcasting media content to a mobile electronic device via a first wireless transmission over a first wireless network; and
unicast bursting the media content to the mobile electronic device via a second wireless transmission over a second wireless network, wherein the second wireless network is different from the first wireless network.

12. The method of claim 11, further comprising receiving data from the mobile electronic device, wherein the received data indicates that broadcast data from the first wireless transmission has been decompressed.

13. The method of claim 11, further comprising storing a predetermined amount of media content in a cache, wherein the predetermined amount of media content is used to unicast burst the media content.

14. The method of claim 13, wherein the cache includes data associated with multiple video channels.

15. A mobile communication device, comprising:
logic to transmit a request for media content;
logic to receive a broadcast transmission of the media content over a first wireless network; and
logic to receive a unicast burst transmission of the media content over a second wireless network, wherein the second wireless network is different from the first wireless network.

16. The mobile communication device of claim 15, further comprising:
logic to display the unicast burst transmission of the media content until broadcast data from the broadcast transmission has been decompressed.

17. The mobile communication device of claim 16, wherein an amount of time between transmitting the request for the media content and displaying the unicast burst transmission of the media content is less than about 500 milliseconds.

18. The mobile communication device of claim 16, wherein an amount of time between transmitting the request for the media content and displaying the unicast burst transmission of the media content is between about 300 milliseconds and 400 milliseconds.

19. The mobile communication device of claim 15, wherein the mobile electronic device includes one of a vehicle mounted device, a cellular telephone, and a personal digital assistant.

20. The mobile communication device of claim 15, further comprising logic to transmit an indication that broadcast data from the broadcast transmission has been decompressed.
